(19) United States
(12) Patent Application Publication
(10) Pub. No.: US 2026/0205881 A1
(43) Pub. Date: Jul. 16, 2026

(54) RADIO ACCESS NETWORK (RAN) DISTRIBUTED UNITS (DUS) AND CENTRALIZED UNITS (CUS) LOAD BALANCING IN A CONTAINERIZED ARCHITECTURE

(71) Applicant: DISH Wireless L.L.C., Englewood, CO (US)

(72) Inventors: Udhayaanandan Tharmalingam, Highlands Ranch, CO (US); Gurpreet Sohi, Parker, CO (US); Ahmed Mostafa, Centennial, CO (US)

(21) Appl. No.: 19/020,736

(22) Filed: Jan. 14, 2025

(51) Int. Cl. H04W 28/086; H04W 28/08

(52) U.S. Cl. CPC H04W 28/086; H04W 28/095; H04W 28/0958

(57) ABSTRACT

Technologies for load balancing in containerized radio access network (RAN) components in a cellular network are described. One method include monitoring a plurality of health parameters associated with each RAN component entity of a plurality of RAN component entity in a containerized computing cluster of the cellular network, wherein each RAN component entity of the plurality of RAN component entities comprises a Distributed Unit (DU) entity or a Centralized Unit (CU) entity; determining whether each health parameter of the plurality of health parameters satisfies a respective threshold criterion of a plurality of threshold criteria; maintaining a load balancing pool for the containerized computing cluster based on a result of the determining, wherein the load balancing pool comprises a list of available RAN component entities; and responsive to receiving a request of data traffic, distributing the data traffic to one or more RAN component entities selected from the load balancing pool.

### BACKGROUND

Cellular networks are highly complex. One type of cellular network is a fifth generation (5G) new radio (NR) cellular network. 5G NR cellular networks have the promise to provide higher throughput, lower latency, and higher availability compared with previous global wireless standards. However, some components in a 5G NR cellular network are preconfigured, and some pre-configurations cannot be dynamically changed, which may compromise such promise.

### BRIEF DESCRIPTION OF THE DRAWINGS

The present disclosure is illustrated by way of example, and not by way of limitation, in the figures of the accompanying drawings.

FIG. 1 is a block diagram of a system implementing load balancing in containerized 5G radio access network (RAN) components in a cellular network according to at least one embodiment.

FIG. 2 is a block diagram of a system including a load balancing manager that implements load balancing in containerized RAN components in a cellular network according to at least one embodiment.

FIGS. 3A and 3B illustrate example load balancing managers that implement load balancing in containerized DUs in a cellular network according to at least one embodiment.

FIGS. 4A and 4B illustrate example load balancing managers that implement load balancing in containerized CUs in a cellular network according to at least one embodiment.

FIGS. 5, 6, and 7 are flow diagrams of example methods of that implement load balancing in containerized RAN components in a cellular network according to at least one embodiment.

FIG. 8 is a block diagram of an example computer system in which embodiments of the present disclosure can operate.

### DETAILED DESCRIPTION

Technologies for load balancing in containerized 5G radio access network (RAN) components in a telecommunications network, such as a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

In the containerized computing environment, network resources can be shared among various containerized entities, and therefore, the network resources become highly available to various cell sites in the network. However, to effectively use such high availability of network resources during lifecycle management and during failures with a local control plane, the load balancing needs to be improved. For example, the load from one cell site is routed to a specific containerized distributed unit (DU), where the mapping between the cell site and the specific containerized DU is pre-configured and cannot be changed even if the containerized DU encounters failure or unavailability. As another example, the load from a containerized DU is routed to a specific containerized centralized unit (CU), where the mapping between the containerized DU and the specific containerized CU is pre-configured and cannot be changed even if the containerized CU encounters failure or unavailability.

Aspects and embodiments of the present disclosure address the above and other deficiencies by providing a system that implements load balancing in containerized 5G radio access network (RAN) components in a cellular network. Specifically, a component of the cellular network (e.g., load balancing manager) may be implemented into a containerized computing cluster of the cellular network. In some implementations, the containerized 5G RAN components may be containerized distributed unit (DU) entities (e.g., DU pods). In some implementations, the containerized 5G RAN components may be containerized centralized unit (CU) entities (e.g., CU pods). The component of the cellular network (e.g., load balancing manager) may consider health parameters associated with each containerized DU entity of containerized DU entities or each containerized CU entity of containerized CU entities in the containerized computing cluster to determine the load balancing among containerized DU entities or the load balancing among containerized CU entities such that the resources of the cellular network can be used more efficiently.

Specifically, the component of the cellular network (e.g., load balancing manager) may monitor the health parameters, or may request and receive the information of the health parameters. In some implementations, the health parameters associated with a containerized DU entity may characterize a health status of at least one of: a stream control transmission protocol (SCTP) traffic, or a layer 1 (L1) or layer 2(L2) service. In some implementations, the health parameters associated with a containerized CU entity may characterize a health status of at least one of: a stream control transmission protocol (SCTP) traffic, or a layer 3 (L3) service.

The component of the cellular network (e.g., load balancing manager) may determine whether one or more health parameters described above associated with each RAN component entity satisfy a respective threshold criterion of various threshold criteria to trigger an adjustment of load balancing pool, where the load balancing pool represents a list of available RAN component entities that can be used to transmit the data traffic for load balancing purpose. The component of the cellular network (e.g., load balancing manager) may maintain a load balancing pool for the containerized computing cluster based on a result of the determination.

In some implementations, the component of the cellular network (e.g., load balancing manager) may compare the health parameters associated with a first DU entity with the respective threshold criteria and determine that each health parameter associated with the first DU entity reaches or exceeds (or not reach or exceed) a respective threshold value, and then the component of the cellular network (e.g., load balancing manager) may add the first DU entity to the DU load balancing pool, wherein the DU load balancing pool represents a list of available DU entities that can be used to transmit the data traffic for load balancing purpose. In another example, the component of the cellular network (e.g., load balancing manager) may determine that at least one health parameter associated with the second DU entity does not reach or exceed (or reaches or exceeds) a respective threshold value, and then the component of the cellular network (e.g., load balancing manager) may remove the second DU entity from the DU load balancing pool. As such, the component of the cellular network (e.g., load balancing manager) may maintain a DU load balancing pool for the containerized computing cluster such that the data traffic can be distributed among the available DU entities for the load balancing purpose.

In some implementations, the component of the cellular network (e.g., load balancing manager) may compare the health parameters associated with a first CU entity with the respective threshold criteria and determine that each health parameter associated with the first CU entity reaches or exceeds (or not reach or exceed) a respective threshold value, and then the component of the cellular network (e.g., load balancing manager) may add the first CU entity to the CU load balancing pool, wherein the CU load balancing pool represents a list of available CU entities that can be used to transmit the data traffic for load balancing purpose. In another example, the component of the cellular network (e.g., load balancing manager) may determine that at least one health parameter associated with the second CU entity does not reach or exceed (or reaches or exceeds) a respective threshold value, and then the component of the cellular network (e.g., load balancing manager) may remove the second CU entity from the CU load balancing pool. As such, the component of the cellular network (e.g., load balancing manager) may maintain a CU load balancing pool for the containerized computing cluster such that the data traffic can be distributed among the available CU entities for the load balancing purpose.

Thereafter, responsive to receiving a request for new data traffic, the component of the cellular network (e.g., load balancing manager) may distribute the data traffic to one or more RAN component entities selected from the load balancing pool. The one or more RAN component entities may be selected according to one or more predefined load balancing policies, for example, such as a round-robin algorithm. The predefined load balancing policy may be customizable. In some implementations, the component of the cellular network (e.g., load balancing manager) may distribute the data traffic to one or more DU entities selected from the DU load balancing pool according to one or more predefined load balancing policies. In some implementations, the component of the cellular network (e.g., load balancing manager) may distribute the data traffic to one or more CU entities selected from the CU load balancing pool according to one or more predefined load balancing policies.

Aspects and embodiments of the present disclosure can use load balancing manager for load balancing of containerized DU entities or load balancing of containerized CU entities in the cellular network, instead of the static traffic distribution. Aspects and embodiments of the present disclosure can improve the efficiency in resource usage and provide enhanced load management. Traffic can be intelligently distributed in the high availability environment provided by the containerized computing architecture. Work can be seamlessly scaling, as new containerized pods are automatically added to the load balancing pool. For example, the ingress controller, combined with the cluster's service model, can effectively balance the load traffic across nodes in the same cluster, ensuring even distribution and optimal resource utilization.

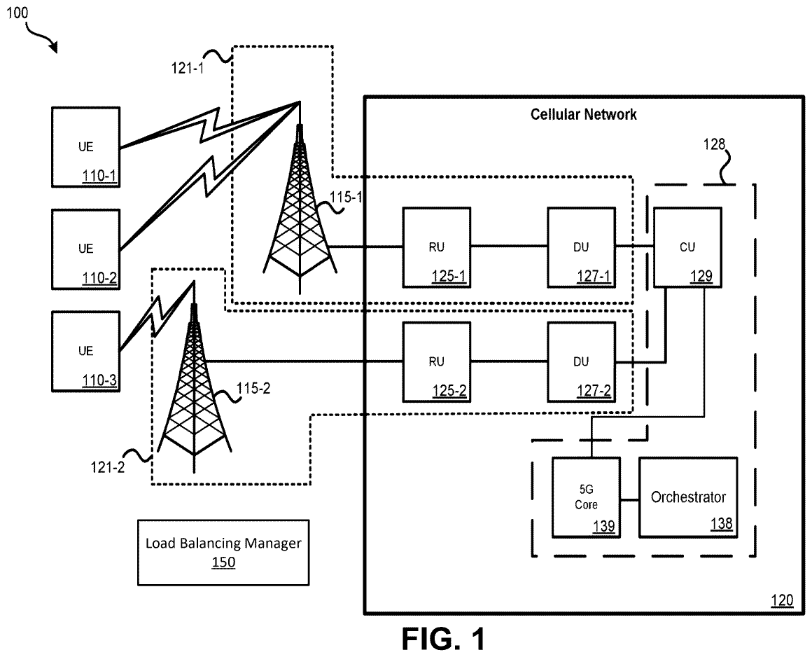

FIG. 1 illustrates an embodiment of a cellular network system 100 (“system 100”). FIG. 1 represents an embodiment of a cellular network which can accommodate the cloud-based architecture. System 100 can include a 5G New Radio (NR) cellular network; other types of cellular networks, such as 6G, 7G, etc. may also be possible. System 100 can include: UEs 110 (UE 110-1, UE 110-2, UE 110-3); base station 121; cellular network 120; radio units 125 (“RUs 125”); distributed units 127 (“DUs 127”); centralized unit 129 (“CU 129”); 5G core 139, and orchestrator 138. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 110 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on the location of individual UEs, UE 110 may use RF to communicate with various base stations of cellular network 120. As illustrated, two base stations 121 are illustrated: base station 121-1 can include: structure 115-1, RU 125-1, and DU 127-1. Structure 115-1 may be any structure to which one or more antennas (not illustrated) of the base station are mounted. Structure 115-1 may be a dedicated cellular tower, a building, a water tower, or any other human-made or natural structure to which one or more antennas can reasonably be mounted to provide cellular coverage to a geographic area. Similarly, base station 121-2 can include: structure 115-2, RU 125-2, and DU 127-2.

Real-world implementations of system 100 can include many (e.g., thousands) of base stations (BSs) and many CUs and 5G core 139. Structures 115 can include one or more antennas that allow RUs 125 to communicate wirelessly with UEs 110. RUs 125 can represent an edge of cellular network 120 where data is transitioned to wireless communication. The radio access technology (RAT) used by RU 125 may be 5G New Radio (NR), or some other RAT. The remainder of cellular network 120 may be based on an exclusive 5G architecture, a hybrid 4G/5G architecture, a 4G architecture, or some other cellular network architecture. Base station 121 equipment may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. One or more DUs, such as DU 127-1, may communicate with CU 129. Collectively, an RU, DU, and CU create a gNodeB, which serves as the radio access network (RAN) of cellular network 120. CU 129 can communicate with 5G core 139. The specific architecture of cellular network 120 can vary by embodiment. Edge cloud server systems outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of cellular network 120, other embodiments of cellular network 120 can vary the arrangement, communication paths, and specific components of cellular network 120. While RU 125 may include specialized radio access componentry to enable wireless communication with UE 110, other components of cellular network 120 may be implemented using either specialized hardware, specialized firmware, and/or specialized software executed on a general-purpose server system. In an O-RAN arrangement, specialized software on general-purpose hardware may be used to perform the functions of components such as DU 127, CU 129, and 5G core 139. Functionality of such components can be co-located or located at disparate physical server systems. For example, certain components of 5G core 139 may be co-located with components of CU 129.

In a possible virtualized O-RAN implementation, CU 129, 5G core 139, and/or orchestrator 138 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 100, cloud-based cellular network components 128 include CU 129, 5G core 139, and orchestrator 138. Such cloud-based cellular network components 128 may be executed as specialized software executed by underlying general-purpose computer servers. Cloud-based cellular network components 128 may be executed on a third-party cloud-based computing platform or a cloud-based computing platform operated by the same entity that operates the RAN. A cloud-based computing platform may have the ability to devote additional hardware resources to cloud-based cellular network components 128 or implement additional instances of such components when requested.

A container orchestration platform (e.g., Kubernetes) can be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 138. Orchestrator 138 can represent various software processes executed by underlying computer hardware. Orchestrator 138 can monitor cellular network 120 and determine the amount and location at which cellular network functions should be deployed to meet or attempt to meet service level agreements (SLAs) across slices of the cellular network.

Orchestrator 138 can allow for the instantiation of new cloud-based components of cellular network 120. As an example, to instantiate a new core function, orchestrator 138 can perform a pipeline of calling the core function code from a software repository incorporated as part of, or separate from, cellular network 120; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 120. Cellular network 120 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 125-1 and DU 127-1, a second set of network slices, which may only partially overlap or may be wholly different from the first set, may be reserved at RU 125-2 and DU 127-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 127, CU 129, orchestrator 138, and 5G core 139 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 139, which can be physically distributed across data centers or located at a central national data center (NDC), can perform various core functions of the cellular network. 5G core 139 can include: network resource management components; policy management components; subscriber management components; and packet control components. Individual components may communicate on a bus, thus allowing various components of 5G core 139 to communicate with each other directly. 5G core 139 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection-and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 120.

5G core 139 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy.

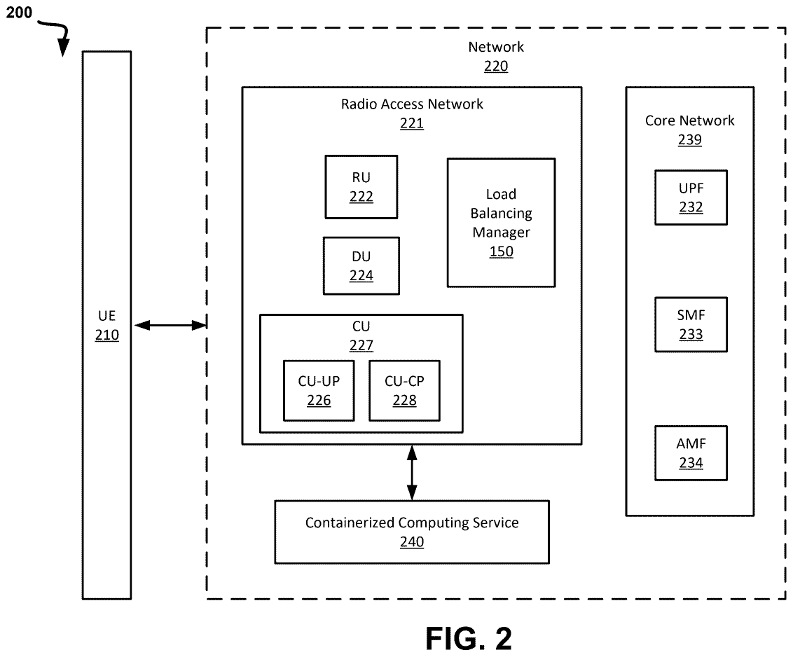

In some embodiments, the system 100 can include a load balancing manager 150 to implement load balancing in containerized 5G radio access network (RAN) components in a cellular network. Further details regarding the operations of the load balancing manager are described below with reference to FIGS. 2-8.

FIG. 2 is a block diagram of an example load balancing manager according to at least one embodiment. Referring to FIG. 2, a network 220 includes one or more radio access network (RAN) 221, and one or more core network 239, according to at least one embodiment. The network 220 may include 4G network, 5G network, 6G network, etc. The network 220 connects user equipment (UE) 210 to the data network (not shown), and the data network can include the Internet, a local area network (LAN), a wide area network (WAN), a private data network, a wireless network, a wired network, or a combination of networks. The UE 210 can include an electronic device with wireless connectivity or cellular communication capability, such as a mobile phone or handheld computing device. In at least one example, the UE 210 can include a 5G smartphone or a 5G cellular device that connects to the RAN 221, via a wireless connection. The UE 210 can include one of a number of UEs not depicted that are in communication with the RAN 221. The UE 210 may include mobile and non-mobile computing devices. The UE 210 may include laptop computers, desktop computers, an Internet-of-Things (IoT) devices, and/or any other electronic computing device that includes a wireless communications interface to access the RAN 221.

The RAN 221 includes a remote radio unit (RU) 222 for wirelessly communicating with UE 210. The remote radio unit (RU) 222 can include a radio unit and may include one or more radio transceivers for wirelessly communicating with UE 210. The remote radio unit (RU) 222 may include circuitry for converting signals sent to and from an antenna of a Base Station into digital signals for transmission over packet networks. In some implementations, the RAN 221 may correspond with a 5G radio Base Station that connects user equipment to the core network 239. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 210.

The RAN 221 can include a new-generation radio access network (NG-RAN) that uses the 5G NR interface. In some embodiments, the distributed unit (DU) 224 and the centralized unit (CU) 227 of the RAN 221 may be co-located with the RU 222. In other embodiments, the DU 224 and the RU 222 may be co-located at a cell site and the centralized unit (CU) 227 may be located within a local data center (LDC). The DU 224 can include a logical node configured to provide functions for the radio link control (RLC) layer, the medium access control (MAC) layer, and the physical layer (PHY) layers. The CU 227 can be partitioned into a CU user plane portion (CU-UP) 226 and a CU control plane portion (CU-CP) 228. The CU-CP 228 may perform functions related to a control plane, such as connection setup, mobility, and security. The CU-UP 226 may perform functions related to a user plane, such as user data transmission and reception functions. In one example, the centralized units (CUs) can include a logical node configured to provide functions for the radio resource control (RRC) layer, the packet data convergence control (PDCP) layer, and the service data adaptation protocol (SDAP) layer. The centralized unit for the control plane (CU-CP) 228 can include a logical node configured to provide functions of the control plane part of the RRC and PDCP. The centralized unit for the user plane(CU-UP) 226 can include a logical node configured to provide functions of the user plane part of the SDAP and PDCP. In some embodiments, the RAN 221 may include virtualized CU units and virtualized DU units. The virtualized DU units can include virtualized versions of distributed units (DUs). The virtualized CU units can include virtualized versions of centralized units (CUs). Virtualizing the control plane and user plane functions allows the centralized units (CUs) to be consolidated in one or more data centers on RAN-based open interfaces.

In some embodiments, the RAN 221 may include a set of one or more remote radio units (RUs) that includes radio transceivers (or combinations of radio transmitters and receivers) for wirelessly communicating with UEs. The set of RUs may correspond with a network of cells (or coverage areas) that provide continuous or nearly continuous overlapping service to UEs, such as UE 210, over a geographic area. Some cells may correspond with stationary coverage areas and other cells may correspond with coverage areas that change over time (e.g., due to movement of a mobile RU).

In some cases, the UE 210 may be capable of transmitting signals to and receiving signals from one or more RUs within the network of cells over time. One or more cells may correspond with a cell site. The cells within the network of cells may be configured to facilitate communication between UE 210 and other UEs and/or between UE 210 and a data network. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

The core network 239 may utilize a cloud-native service-based architecture (SBA) in which different core network functions (e.g., authentication, security, session management, and core access and mobility functions) are virtualized and implemented as loosely coupled independent services that communicate with each other, for example, using hypertext transfer protocol (HTTP) protocols and APIs. In some cases, control plane (CP) functions may interact with each other using the service-based architecture. In at least one embodiment, a microservices-based architecture in which software is composed of small independent services that communicate over well-defined APIs may be used for implementing some of the core network functions. For example, control plane (CP) network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The core network 239 may include a set of network elements that are configured to offer various data and telecommunications services to subscribers or end users of user equipment, such as UE 210. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

The primary core network functions can include the access and mobility management function (AMF) 234, the session management function (SMF) 233, and the user plane function (UPF) 232. The AMF 334 may interface with UE 210, act as a single-entry point for a UE connection, and perform mobility management, registration management, and connection management between data network and UE 210. The AMF 334 may interface with the SMF 333 to track user sessions. The AMF 334 may interface with a network slice selection function (NSSF) 338 to select network slice instances for user equipment. When user equipment is leaving a first coverage area and entering a second coverage area, the AMF 334 may be responsible for coordinating the handoff between the coverage areas whether the coverage areas are associated with the same radio access network or different radio access networks. The SMF 333 may perform session management, user plane selection, and Internet Protocol (IP) address allocation. After the Access Gateway Function (AGF) authenticates the subscriber and establishes a protocol data unit (PDU) session, the SMF 333 may select the UPF for the subscriber.

The UPF 232 may provide subscriber tunnel encapsulations enabled by the general packet radio service (GPRS) tunneling protocol, packet processing including routing and forwarding, quality of service (QoS) handling, packet data unit (PDU) session management, policy enforcement, statistics gathering and reporting, lawful intercept requests processing, and optional advanced services. The UPF 232 may serve as an ingress and egress point for user plane traffic and provide anchored mobility support for user equipment. The UPF 232 may be implemented as a software process or application running within a virtualized infrastructure or a cloud-based compute and storage infrastructure.

The UPF 232 may transfer downlink data received from the data network to the UE 210, via the RAN 221 and/or transfer uplink data received from the UE 210 to the data network via the RAN 221. An uplink can include a radio link though which UE 210 transmits data and/or control signals to the RAN 221. A downlink can include a radio link through which the RAN 221 transmits data and/or control signals to the UE 210.

Uplink packets arriving from the RAN 221 may use a general packet radio service (GPRS) tunneling protocol (or GTP) to reach the UPF 232. The GPRS tunneling protocol for the user plane may support multiplexing of traffic from different PDU sessions by tunneling user data over the interface N3 between the RAN 221 and the UPF 232. The UPF 232 may remove the packet headers belonging to the GTP tunnel before forwarding the user plane packets towards the data network. As the UPF 232 may provide connectivity towards other data networks in addition to the data network, the UPF 232 ensures that the user plane packets are forwarded towards the correct data network. Each GTP tunnel may belong to a specific PDU session. Each PDU session may be set up towards a specific data network name (DNN) that uniquely identifies the data network to which the user plane packets should be forwarded. The UPF 232 may keep a record of the mapping between the GTP tunnel, the PDU session, and the DNN for the data network to which the user plane packets are directed.

Downlink packets arriving from the data network are mapped onto a specific quality of service (QoS) flow belonging to a specific PDU session before forwarded towards the appropriate RAN 221. A QoS flow may correspond with a stream of data packets that have equal QoS. The PDU session may utilize one or more QoS flows to exchange traffic (e.g., data and voice traffic) between the UE 210 and the data network. The one or more QoS flows can include the finest granularity of QoS differentiation within the PDU session. The PDU session may belong to a network slice instance through the network 220. To establish user plane connectivity from the UE 210 to the data network, the AMF 234 that supports the network slice instance may be selected and a PDU session via the network slice instance may be established. In some cases, the PDU session may be of type IPv4 or IPv6 for transporting IP packets. The RAN 221 may be configured to establish and release parts of the PDU session that cross the radio interface.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) (not shown) for providing application services. Application-level session information may be exchanged between the AF and PCF (e.g., bandwidth requirements for QoS). In some cases, when the UE 210 requests access to resources, such as establishing a PDU session or a QoS flow, the PCF may dynamically decide if the UE 210 should grant the requested access based on a location of the UE 210.

The network 220 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a network, such as an instantiation of the network 220. In some cases, the network 220 may support customized policy configuration and enforcement between network slices per service level agreements (SLAs) within the radio access network (RAN) 221. User equipment, such as UE 210, may connect to multiple network slices at the same time (e.g., eight different network slices). In some cases, the network 220 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

Virtualization allows virtual hardware to be created and decoupled from the underlying physical hardware. One example of a virtualized component is a virtual router (or a vRouter). Another example of a virtualized component is a virtual machine. A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64GB virtual disk) for the virtual machine. Another example of a virtualized component is a software container or an application container that encapsulates an application's environment. In some embodiments, applications and services may be run using virtual machines instead of containers in order to improve security. A common virtual machine may also be used to run applications and/or containers for a number of closely related network services.

The network 220 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

As an example, the network 220 may include a containerized computing service platform 240, which can provide resources and services (e.g., micro-services) for the development and execution of applications owned or managed by multiple users. The containerized computing service platform 240 may provide computing clusters, and a computing cluster may be a group of physical or virtual host machines that run containerized applications and may include virtualized computing entities that represent resources in the cluster, such as virtual machines, nodes, storage volumes, and networks. In some implementations, the computing cluster may be managed by a container orchestration system (e.g., Kubernetes) to manage containerized workloads and services and facilitate declarative configuration and automation In some implementations, the computing cluster may include a control plane and a collection of nodes including a master node and one or more worker notes. The control plane is a collection of components that can make global control and management decisions about a cluster and can select a node for running a pod based on resource availability. A pod refers to a group of one or more containers, with shared storage and network resources, and a specification for running the containers. A node providing computing functionality may provide the execution environment for an application of the system 200. In some implementations, the node may include a virtual machine or a container that is hosted on a physical machine and may be implemented as part of the clouds. In some implementations, the containerized computing service platform 240 may provide one or more nodes that can be used as containerized DUs (e.g., DU pods). In some implementations, the containerized computing service platform 240 may provide one or more nodes that can be used as containerized DUs (e.g., DU pods).

In some implementations, RAN 221 may include the load balancing manager 150 to implement load balancing among containerized same-type RAN components (i.e., among containerized DUs or among containerized CUs). In some implementations, one or more load balancing managers may be included in other part(s) of the network 220.

In some implementations, the load balancing manager 150 may communicate with the containerized computing service platform 240 to receive and monitor information of health parameters associated with each containerized DU in RAN 221. In some implementations, the RAN component running in the containerized computing service platform 240 may listen to the load balancing manager 150 for health check request. The health parameters associated with a containerized DU in RAN 221 may characterize at least one of: a health status of the stream control transmission protocol (SCTP) traffic, or layer 1 (L1) or layer 2 (L2) services.

The SCTP is a protocol used between RAN 221 and AMF 234, and the SCTP traffic may include one or more SCTP packets. In some implementations, the health status of the SCTP traffic may be reflected by the checksum value specified in the SCTP packet. The checksum uses the cyclic redundancy check algorithm to detect errors that might have been introduced during data transmission.

L1 may include physical layer, which acts as the foundation for seamless communication, transforming data into radio signals and back again. The layer 1 service may include error detection and correction, data rate matching, channel mapping, modulation and demodulation, frequency and time synchronization, channel condition monitoring, etc. The health status of the L1 service may be reflected by the user throughput of L1 service. The health status of the L1 service may be retrieved from the underlying Kubernetes platform.

L2 may include a media access control (MAC) layer, a radio link control (RLC) layer, packet data convergence protocol (PDCP) layer, service data adaptation protocol (SDAP) layer. The MAC layer service may include managing radio resources and ensuring efficient communication, such as beam management, performing random access procedure, mapping and multiplexing, scheduling, error correction, etc. The RLC layer service may including bridging the gap between upper layer data and the MAC layer and ensuring reliable and efficient delivery over the air interface, such as data transferring, error correction, etc. The PDCP layer service may include securing and streamlining user plane (UP) data transmission in 5G networks, such as data transferring, duplicate detection, etc. The SDAP layer service may include ensuring efficient and tailored data delivery by translating user plane data to meet the specific requirements of different services and applications, such as priority management, flow optimization, etc. The health status of the L2 service may be reflected by the user throughput of the L2 service. The health status of the L2 service may be retrieved from the underlying Kubernetes platform.

In some implementations, the health parameters associated with a containerized DU in RAN 221 may be associated with data transaction handled by containerized DU, an available capacity of containerized DU, or interference to containerized DU from other network elements. The available capacity of containerized DU may comprise at least one of: the available capacity of memory allocated to the containerized DU, the available capacity of storage allocated to the containerized DU, the available number of CPU allocated to the containerized DU, or the available bandwidth of network interconnection allocated to the containerized DU.

In some implementations, the load balancing manager 150 may communicate with the containerized computing service platform 240 to receive and monitor information of health parameters associated with each containerized CU in RAN 221. The health parameters associated with a containerized CU in RAN 221 may characterize at least one of: a health status of the stream control transmission protocol (SCTP) traffic, or layer 3 (L3) services. L3 may include radio resource control (RRC) layer. The MAC layer service may include broadcasting essential network information to both the Non-Access Stratum (NAS) and Access Stratum (AS), establishing and maintaining the connection between UE and RAN 221, managing the initial setup, authentication and authorization, handling disconnections, etc. The health status of the L3 service may be reflected by the user throughput of the L3 service. The health status of the L3 service may be retrieved from the underlying Kubernetes platform.

In some implementations, the health parameters associated with a containerized CU in RAN 221 may be associated with data transaction handled by containerized CU, a capacity of containerized CU, or interference to containerized CU from other network elements. The available capacity of containerized CU may comprise at least one of: the available capacity of memory allocated to the containerized CU, the available capacity of storage allocated to the containerized CU, the available number of CPU allocated to the containerized CU, or the available bandwidth of network interconnection allocated to the containerized CU.

In some implementations, to monitor the health parameters associated with each containerized DU and each containerized CU in RAN 221 that are described above, the load balancing manager 150 may compare the monitored health parameters with various threshold criteria for load balancing to determine whether one or more health parameters satisfy at least one threshold criterion. In some implementations, the load balancing manager 150 may determine that when a specific health parameter described above reaches or exceeds a threshold value, the threshold criterion is satisfied. In some implementations, the load balancing manager 150 may determine that when each of several parameters described above reaches or exceeds a respective threshold value, the threshold criterion is satisfied.

In some implementations, the load balancing manager 150 may maintain a load balancing pool for the containerized computing cluster based on a result of determining whether each health parameter of the plurality of health parameters satisfies a respective threshold criterion of a plurality of threshold criteria, where the load balancing pool comprises a list of available RAN component entities for load balancing purpose.

Responsive to determining that one or more health parameters satisfy at least one threshold criterion, the load balancing manager 150 may add the corresponding DU(s) or CU(s) to a corresponding load balancing pool. In some implementations, responsive to determining that one or more health parameters of a DU satisfy at least one threshold criterion, the load balancing manager 150 may add the DU to a DU load balancing pool. In some implementations, responsive to determining that one or more health parameters of a CU satisfy at least one threshold criterion, the load balancing manager 150 may add the CU to a CU load balancing pool.

Responsive to determining that one or more health parameters do not satisfy at least one threshold criterion, the load balancing manager 150 may remove the corresponding DU(s) or CU(s) from a corresponding load balancing pool. In some implementations, responsive to determining that one or more health parameters of a DU do not satisfy at least one threshold criterion, the load balancing manager 150 may remove the DU from a DU load balancing pool. In some implementations, responsive to determining that one or more health parameters of a CU do not satisfy at least one threshold criterion, the load balancing manager 150 may remove the CU from a CU load balancing pool.

In one example, a first health parameter associated with a first containerized DU may be the traffic capacity of the SCTP traffic, and a first threshold criterion may define a maximum value of the traffic capacity of the SCTP traffic associated with the first containerized DU. The load balancing manager 150 may receive or monitor the first health parameter, and compare the first health parameter with the first threshold criterion. When the value of the first health parameter is not larger than the maximum number defined in the first threshold criterion, the load balancing manager 150 may determine that the first parameter satisfies the first threshold criterion, which means to keep or add the first containerized DU included in the load balancing pool. When the value of the first health parameter is larger than the maximum number defined in the first threshold criterion, the load balancing manager 150 may determine that the first parameter does not satisfy the first threshold criterion, which means to keep or remove the first containerized DU from the load balancing pool.

In some implementations, the load balancing manager 150 may receive a request for new data traffic. The load balancing manager 150 may select a DU or CU from the corresponding load balancing pool for the new data traffic. The load balancing manager 150 may route the data to the selected DU or CU.

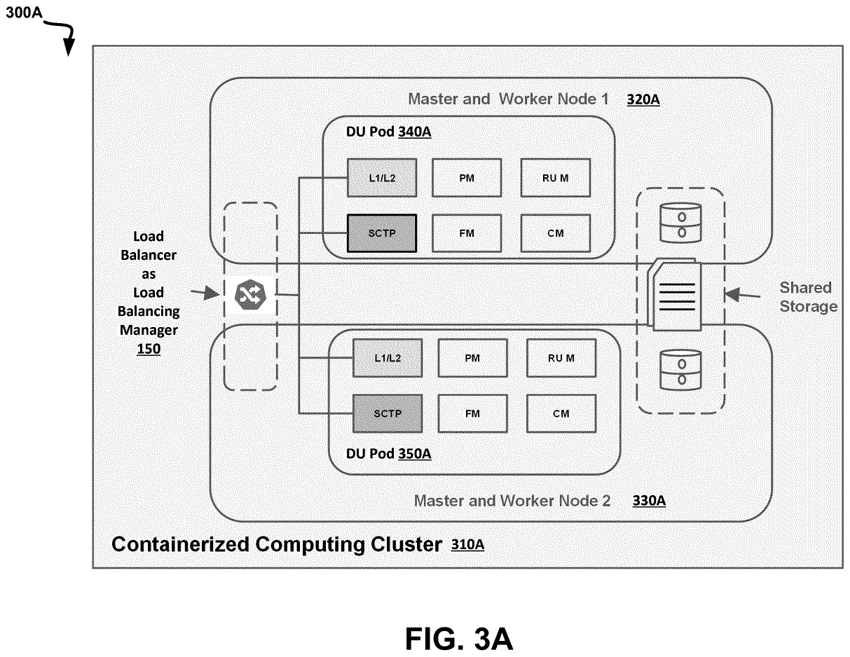

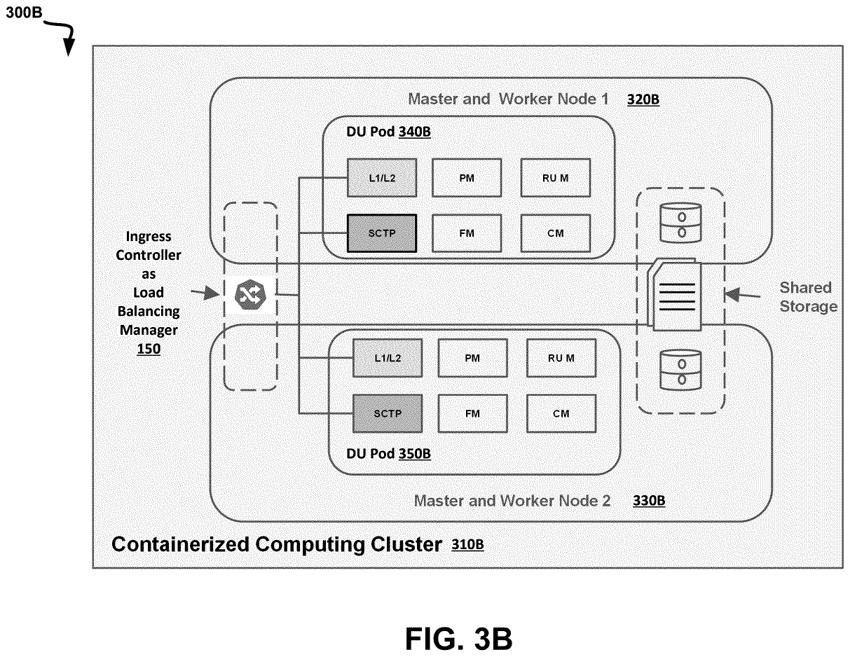

FIGS. 3A and 3B illustrates example load balancing managers that implement load balancing of DU pods in a containerized computing cluster. Referring to FIG. 3A, the system 300A may include a containerized computing cluster 310A. The containerized computing cluster 310A may include a first node 320A and a second node 330A. The first node 320A may include one or more DU pods 340A, and the second node 330A may include one or more DU pods 350A. Each DU pod may include information of health parameters including a health status of the SCTP traffic, and a health status of the L1/L2 service. Each DU pod may include information including the performance management (PM), the fault management (FM), the radio unit management (RUM), and the configuration management (CM).

In FIG. 3A, the load balancing manager 150 may be implemented as a load balancer. The load balancer may be implemented as a software to distribute network traffic across multiple DU pods in the containerized computing cluster 310A. The load balancing manager 150 may initiate a health check request and send the request to the DU pods. The load balancing manager 150 may monitor the health parameters associated with DU pods, determine whether these parameters satisfy the respective threshold criteria, maintain a DU load balancing pool based on the determination, and responsive to receiving a request for data traffic, distribute the data traffic to one or more DU pods selected from the DU load balancing pool. While the legacy load balancer supports only HTTP and HTTPS, both RAN network function vendors and load balancer vendors can adapt the load balancing manager, as 5G networks heavily depend on virtualization and containerization to achieve low latency, high performance, dynamic scaling, and operational efficiency.

FIG. 3B illustrates a similar example of the load balancing manager 150 except that in FIG. 3B, the load balancing manager 150 may be implemented as an ingress controller. In some implementations, ingress refers to an API object that manages external access to services, and therefore, the ingress controller can route a request to a corresponding service, and the service is used to identify a corresponding pod (and corresponding node). In some implementations, the ingress controller routes traffic to the appropriate service within the cluster, which then distribute the traffic across the pods running on different nodes. For example, this can be achieved through Kubernetes services (e.g., ClusterIP, NodePort, or LoadBalancer) with a default round-robin algorithm. In another example, a network slice can adapt this method by leveraging the ingress controller APIs to trigger a policy to steer a quality performance index (QPI) intent traffic towards a specific load balancing pool. In some cases, external traffic entering via a cloud provider's load balancer (e.g., in a LoadBalancer service) will also be directed by the ingress controller to backend pods across the cluster. In some cases, for enhanced locality or specific requirements, the load balancing manager 150 can configure topology-aware routing (e.g., the externalTrafficPolicy set to local) or use customized ingress controller features for more sophisticated load balancing. As shown in FIGS. 3A and 3B, in some cases, the data traffic may be distributed to DU pods on a different nodes. In some cases, the data traffic may be distributed to DU pods on the same node.

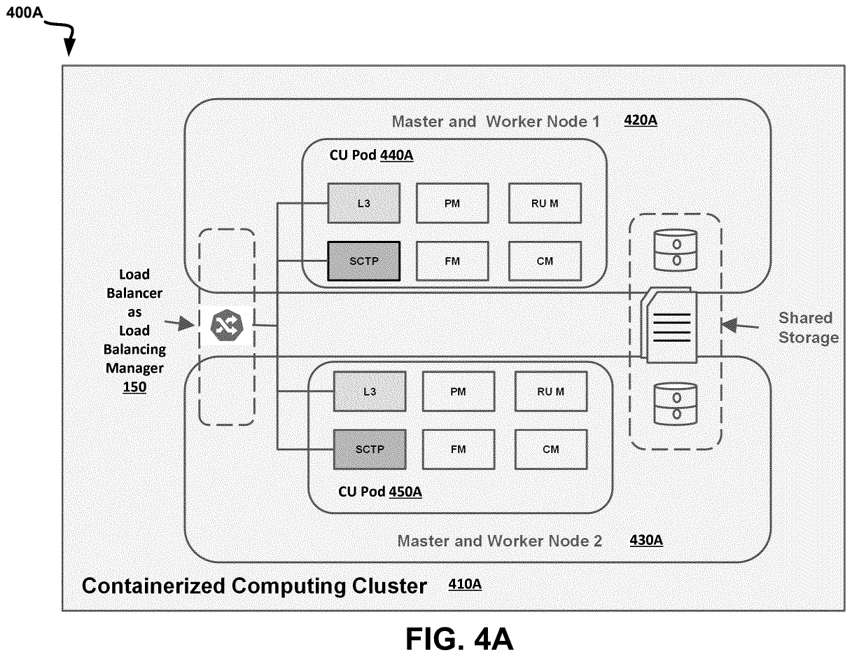

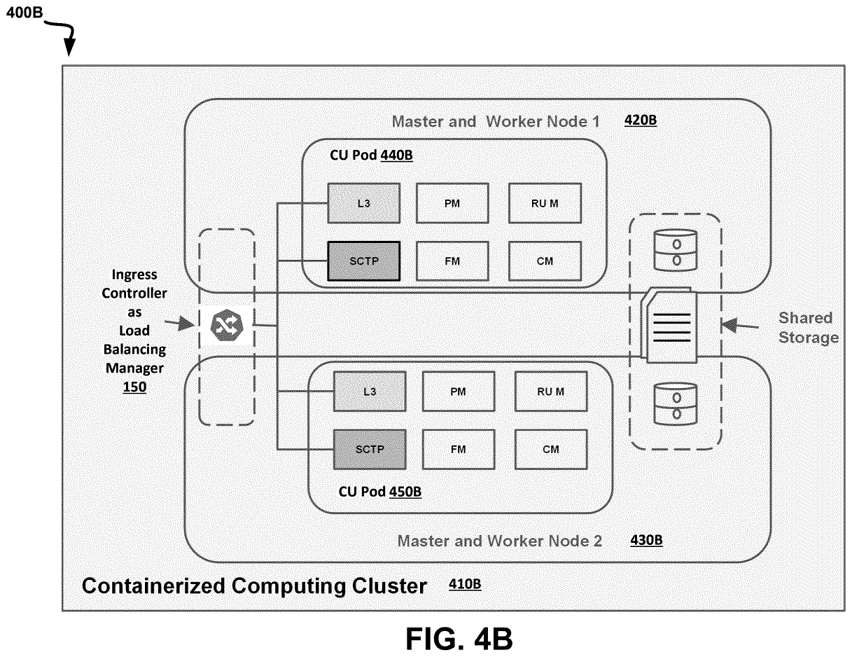

FIGS. 4A and 4B illustrates example load balancing managers that implement load balancing of CU pods in a containerized computing cluster. Referring to FIG. 4A, the system 400A may include a containerized computing cluster 410A. The containerized computing cluster 410A may include a first node 420A and a second node 430A. The first node 420A may include one or more CU pods 440A, and the second node 430A may include one or more CU pods 450A. Each CU pod may include information of health parameters including a health status of the SCTP traffic, and a health status of the L3 service. Each CU pod may include information including the performance management (PM), the fault management (FM), the radio unit management (RUM), and the configuration management (CM).

In FIG. 4A, the load balancing manager 150 may be implemented as a load balancer. The load balancer may be implemented as a software to distribute network traffic across multiple CU pods in the containerized computing cluster 310A. The load balancing manager 150 may monitor the health parameters associated with CU pods, determine whether these parameters satisfy the respective threshold criteria, maintain a CU load balancing pool based on the determination, and responsive to receiving a request for data traffic, distribute the data traffic to one or more CU pods selected from the CU load balancing pool. FIG. 4B illustrates a similar example of the load balancing manager 150 except that in FIG. 4B, the load balancing manager 150 may be implemented as an ingress controller described above. As shown in FIGS. 4A and 4B, in some cases, the data traffic may be distributed to CU pods on a different nodes. In some cases, the data traffic may be distributed to CU pods on the same node.

In some implementations, a system (e.g., system 100 in FIG. 1, or system 200 in FIG. 2) may include a computing system to facilitate a cellular network (e.g., the cellular network 120 in FIG. 1, or 5G network in FIG. 2), the computing system may include one or more processing devices and memory communicatively coupled with and readable by the one or more processing devices and having stored therein processor-readable instructions which, when executed by the one or more processing devices, cause the one or more processing devices to perform operations described herein.

The computing system may be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The processing device may represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like. Processing device may be configured to execute processor-readable instructions for performing the operations and steps discussed herein.

The memory may represent any combination of the different types of non-volatile memory devices (e.g., not-and (NAND) type flash memory and write-in-place memory, such as a three-dimensional cross-point (“3D cross-point”) memory device) and/or volatile memory devices (e.g., random access memory (RAM), such as dynamic random access memory (DRAM) and synchronous dynamic random access memory (SDRAM)). Examples of memory include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory further include a dual in-line memory module (DIMM), a small outline DIMM (SO-DIMM), and various types of non-volatile dual in-line memory modules (NVDIMMs).

In some implementations, a system (e.g., system 100 in FIG. 1, or system 200 in FIG. 2) may include one or more non-transitory, computer-readable storage media having computer-readable instructions thereon which, when executed by one or more processing devices, cause the one or more processing devices to perform operations described herein. The term “computer-readable storage medium” should be taken to include a single medium or multiple media that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media. Processor-readable instructions or computer-readable instructions may include instructions to implement functionality corresponding to a load balancing manager (e.g., the load balancing manager of FIGS. 1-4B).

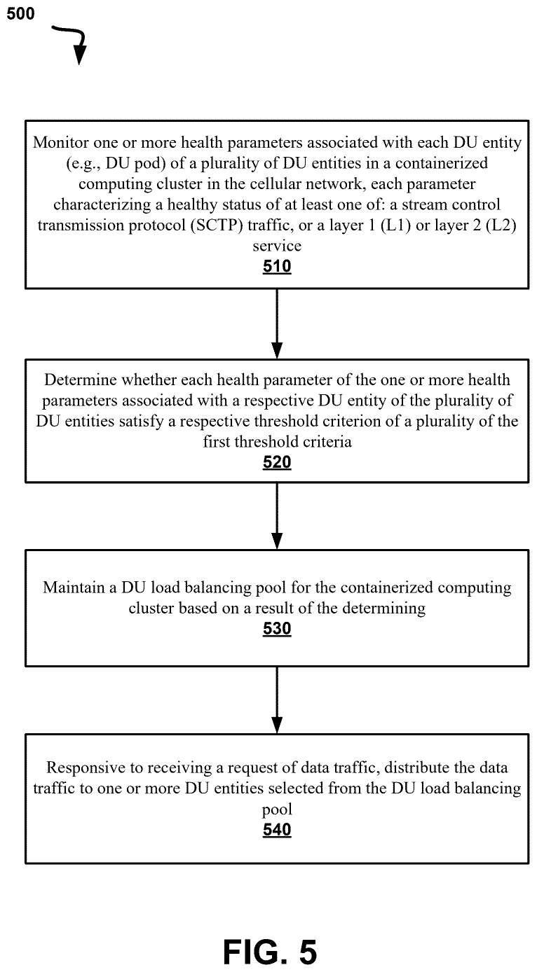

FIGS. 5, 6, and 7 are flow diagrams of methods 500, 600, and 700 of load balancing in containerized 5G radio access network (RAN) components in a cellular network according to at least one embodiment. The of methods 500, 600, and 700 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the methods 500, 600, and 700 are performed by the system 100 of FIG. 1. In one embodiment, the methods 500, 600, and 700 are performed by the load balancing manager of FIGS. 1-2. In one embodiment, the method 500 is performed by the load balancing manager 150 of FIGS. 3A and 3B, the method 600 is performed by the load balancing manager 150 of FIGS. 4A and 4B, and the method 700 is performed by the load balancing manager 150 of FIGS. 3A and 3B, 4A and 4B. In one embodiment, the method 500 is specific to the load balancing of DUs, the method 600 is specific to the load balancing of CUs, and the method 700 may be specific to the load balancing of DUs or CUs.

Referring to FIG. 5, at operation 510, the processing logic may monitor one or more health parameters associated with each DU entity (e.g., DU pod) of a plurality of DU entities in a containerized computing cluster in the cellular network. In some implementations, each health parameter may characterize a health status of at least one of: a stream control transmission protocol (SCTP) traffic, or a layer 1 (L1) or layer 2 (L2) service. In some implementations, the containerized computing cluster comprises a plurality of nodes, and one or more DU entities of the plurality of DU entities runs on one of the plurality of nodes.

At operation 520, the processing logic may determine whether each health parameter of the one or more health parameters associated with a respective DU entity of the plurality of DU entities satisfies a respective threshold criterion of a plurality of threshold criteria. In some implementations, each threshold criterion comprises at least one of: a minimum value of a respective health parameter, a maximum value of the respective health parameter, or a range of values of the respective health parameter.

At operation 530, the processing logic may maintain a DU load balancing pool for the containerized computing cluster according to a result from the determining, where the DU load balancing pool provides a list of DU entities to be used for new data traffic. In some implementations, the DU load balancing pool may be initiated with a list of all DU entities in the containerized computing cluster. In some implementations, maintaining the DU load balancing pool may include adding a specific DU entity to the list or removing a specific DU entity from the list.

In some implementations, responsive to determining a health parameter associated with the first DU entity satisfy the first threshold criterion, the processing logic may keep the first DU entity in the DU load balancing pool or add the first DU entity to the DU load balancing pool.

In some implementations, responsive to determining a health parameter associated with the second DU entity does not satisfy the second threshold criterion, the processing logic may remove the second DU entity from the DU load balancing pool or keep the second DU entity from the DU load balancing pool.

At operation 540, responsive to receiving a request of data traffic, the processing logic may distribute the data traffic to one or more DU entities selected from the DU load balancing pool. In some implementations, the processing logic may select the one or more DU entities from the DU load balancing pool according to a load balancing policy, where the load balancing policy comprises a round-robin algorithm.

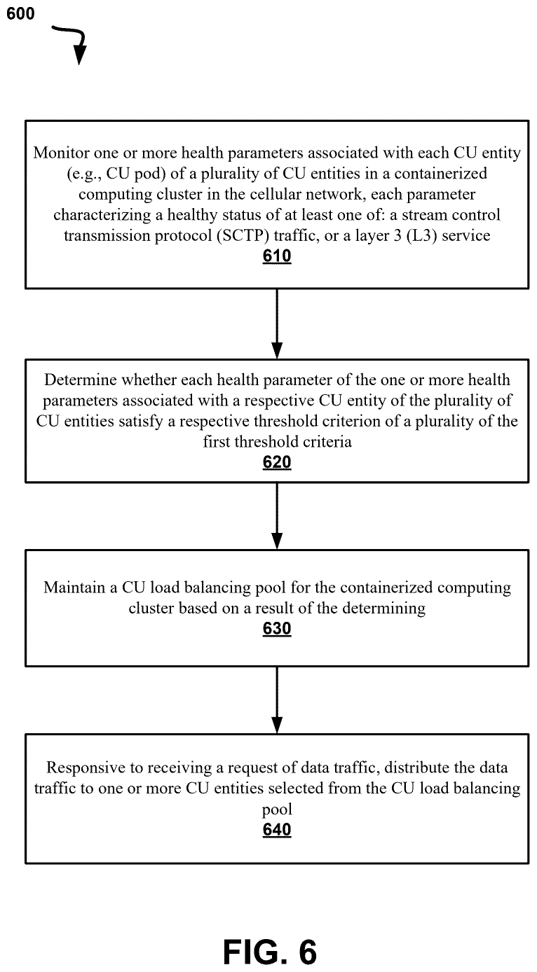

Referring to FIG. 6, at operation 610, the processing logic may monitor one or more health parameters associated with each CU entity (e.g., CU pod) of a plurality of CU entities in a containerized computing cluster in the cellular network. In some implementations, each health parameter may characterize a health status of at least one of: a stream control transmission protocol (SCTP) traffic, or a layer 1 (L1) or layer 2 (L2) service. In some implementations, the containerized computing cluster comprises a plurality of nodes, and one or more CU entities of the plurality of CU entities runs on one of the plurality of nodes.

At operation 620, the processing logic may determine whether each health parameter of the one or more health parameters associated with a respective CU entity of the plurality of CU entities satisfies a respective threshold criterion of a plurality of threshold criteria. In some implementations, each threshold criterion comprises at least one of: a minimum value of a respective health parameter, a maximum value of the respective health parameter, or a range of values of the respective health parameter.

At operation 630, the processing logic may maintain a CU load balancing pool for the containerized computing cluster according to a result from the determining, where the CU load balancing pool provides a list of CU entities to be used for new data traffic. In some implementations, the CU load balancing pool may be initiated with a list of all CU entities in the containerized computing cluster. In some implementations, maintaining the CU load balancing pool may include adding a specific CU entity to the list or removing a specific CU entity from the list.

In some implementations, responsive to determining a health parameter associated with the first CU entity satisfy the first threshold criterion, the processing logic may keep the first CU entity in the CU load balancing pool or add the first CU entity to the CU load balancing pool.

In some implementations, responsive to determining a health parameter associated with the second CU entity does not satisfy the second threshold criterion, the processing logic may remove the second CU entity from the CU load balancing pool or keep the second CU entity from the CU load balancing pool.

At operation 640, responsive to receiving a request of data traffic, the processing logic may distribute the data traffic to one or more CU entities selected from the CU load balancing pool. In some implementations, the processing logic may select the one or more CU entities from the CU load balancing pool according to a load balancing policy, where the load balancing policy comprises a round-robin algorithm.

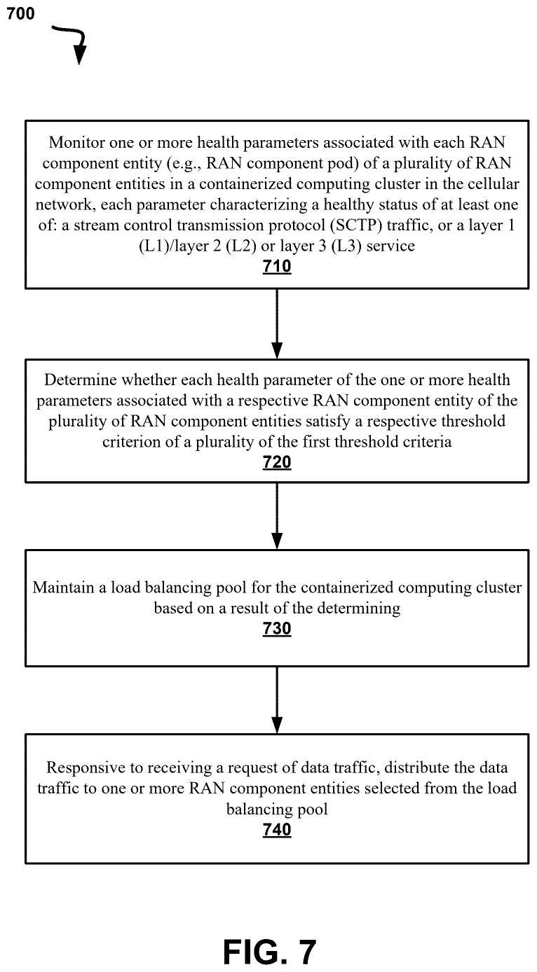

Referring to FIG. 7, at operation 710, the processing logic may monitor one or more health parameters associated with each RAN component entity (e.g., DU pod or CU pod) of a plurality of RAN component entities in a containerized computing cluster in the cellular network, wherein each RAN component of the plurality of RAN components comprises Distributed Unit (DU) or Centralized Unit (CU).

In some implementations, each health parameter may characterize a health status of at least one of: a stream control transmission protocol (SCTP) traffic, or a layer 1 (L1)/layer 2 (L2) service or a layer 3 (L3) service. In some implementations, the containerized computing cluster comprises a plurality of nodes, and one or more RAN component entities of the plurality of RAN component entities runs on one of the plurality of nodes.

At operation 720, the processing logic may determine whether each health parameter of the one or more health parameters associated with a respective RAN component entity of the plurality of RAN component entities satisfies a respective threshold criterion of a plurality of threshold criteria. In some implementations, each threshold criterion comprises at least one of: a minimum value of a respective health parameter, a maximum value of the respective health parameter, or a range of values of the respective health parameter.

At operation 730, the processing logic may maintain a RAN component load balancing pool for the containerized computing cluster according to a result from the determining, where the RAN component load balancing pool provides a list of RAN component entities to be used for new data traffic. In some implementations, the RAN component load balancing pool may be initiated with a list of all RAN component entities in the containerized computing cluster. In some implementations, maintaining the RAN component load balancing pool may include adding a specific RAN component entity to the list or removing a specific RAN component entity from the list.

In some implementations, responsive to determining a health parameter associated with the first RAN component entity satisfy the first threshold criterion, the processing logic may keep the first RAN component entity in the RAN component load balancing pool or add the first RAN component entity to the RAN component load balancing pool.

In some implementations, responsive to determining a health parameter associated with the second RAN component entity does not satisfy the second threshold criterion, the processing logic may remove the second RAN component entity from the RAN component load balancing pool or keep the second RAN component entity from the RAN component load balancing pool.

At operation 740, responsive to receiving a request of data traffic, the processing logic may distribute the data traffic to one or more RAN component entities selected from the RAN component load balancing pool. In some implementations, the processing logic may select the one or more RAN component entities from the RAN component load balancing pool according to a load balancing policy, where the load balancing policy comprises a round-robin algorithm.

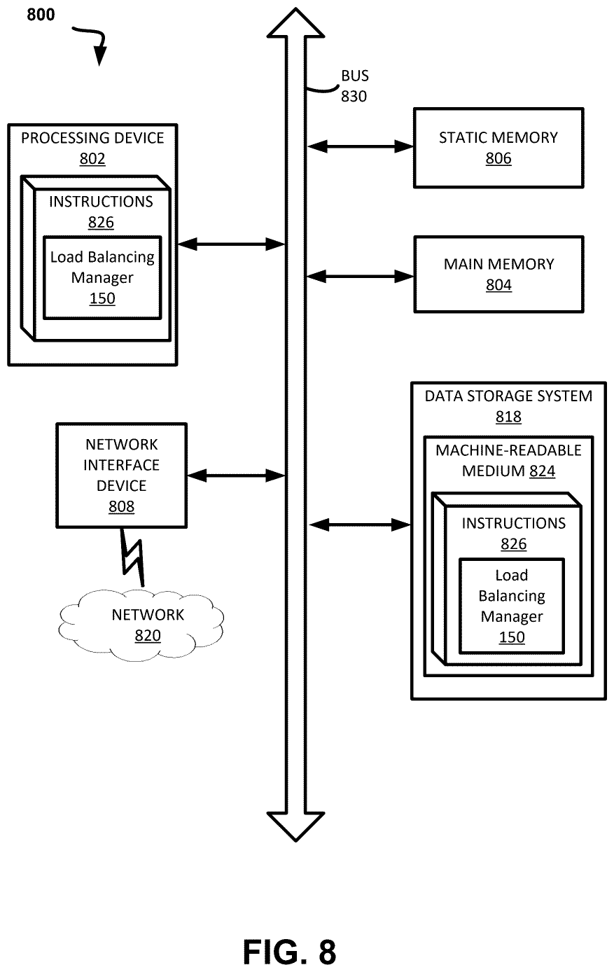

FIG. 8 illustrates an example machine of a computer system 800 within which a set of instructions, for causing the machine to perform any one or more of the methodologies discussed herein, can be executed. In some embodiments, the computer system 800 can be used to perform the operations of a controller (e.g., to execute an operating system to perform operations corresponding to the load balancing manager 150 of FIGS. 1-4B). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820. The network 820 may correspond to the cellular network 120 of FIG. 1, or the network 220 of FIG. 2.

The data storage system 818 can include a machine-readable storage medium 824 (also known as a computer-readable medium or a non-transitory computer-readable storage medium) on which is stored one or more sets of instructions 826 or software embodying any one or more of the methodologies or functions described herein. The instructions 826 can also reside, completely or at least partially, within the main memory 804 and/or within the processing device 802 during execution thereof by the computer system 800, the main memory 804 and the processing device 802 also constituting machine-readable storage media. In one embodiment, the processing device 802, the network interface 808, and the network 820 can correspond to the system 100 of FIG. 1, or the system 200 of FIG. 2.

In one embodiment, the instructions 826 include instructions to implement functionality corresponding to the load balancing manager 150 of FIGS. 1-4B. While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method of load balancing in containerized radio access network (RAN) components in a cellular network, the method comprising:
monitoring a plurality of health parameters associated with each RAN component entity of a plurality of RAN component entity in a containerized computing cluster of the cellular network, wherein each RAN component entity of the plurality of RAN component entities comprises a Distributed Unit (DU) entity or a Centralized Unit (CU) entity;
determining whether each health parameter of the plurality of health parameters satisfies a respective threshold criterion of a plurality of threshold criteria;
maintaining a load balancing pool for the containerized computing cluster based on a result of the determining, wherein the load balancing pool comprises a list of available RAN component entities; and
responsive to receiving a request of data traffic, distributing the data traffic to one or more RAN component entities selected from the load balancing pool.

2. The method of claim 1, wherein the plurality of RAN component entities comprise a plurality of DU entities,
wherein each health parameter characterizes a health status of at least one of: a stream control transmission protocol (SCTP) traffic, or a layer 1 (L1) or layer 2 (L2) service,
wherein the list of available RAN component entities comprises a list of available DU entities, and
wherein distributing the data traffic to the one or more RAN component entities selected from the load balancing pool comprises distributing the data traffic to one or more DU entities selected from the load balancing pool.

3. The method of claim 1, wherein the plurality of RAN component entities comprise a plurality of CU entities,
wherein each health parameter characterizes a health status of at least one of: a stream control transmission protocol (SCTP) traffic, or a layer 3 (L3) service,
wherein the list of available RAN component entities comprises a list of available CU entities, and
wherein distributing the data traffic to the one or more RAN component entities selected from the load balancing pool comprises distributing the data traffic to one or more CU entities selected from the load balancing pool.

4. The method of claim 1, wherein maintaining the load balancing pool for the containerized computing cluster based on the result of the determining comprises:
responsive to determining a plurality of health parameters associated with a first RAN component entity satisfy a first threshold criterion of the plurality of threshold criteria, adding the first RAN component entity to the load balancing pool.

5. The method of claim 1, wherein maintaining the load balancing pool for the containerized computing cluster based on the result of the determining comprises:
responsive to determining at least one health parameter of a plurality of health parameters associated with a second RAN component entity does not satisfy a second threshold criterion of the plurality of threshold criteria, removing the second RAN component entity from the load balancing pool.

6. The method of claim 1, wherein each threshold criterion of the plurality of threshold criteria comprises at least one of: a minimum value of a respective health parameter, a maximum value of the respective health parameter, or a range of values of the respective health parameter.

7. The method of claim 1, further comprising:
selecting the one or more RAN component entities from the load balancing pool according to a predefined load balancing policy, wherein the predefined load balancing policy comprises a round-robin algorithm.

8. A computing system to facilitate a cellular network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
monitoring a plurality of health parameters associated with each radio access network (RAN) component entity of a plurality of RAN component entity in a containerized computing cluster of the cellular network, wherein each RAN component entity of the plurality of RAN component entities comprises a Distributed Unit (DU) entity or a Centralized Unit (CU) entity;
determining whether each health parameter of the plurality of health parameters satisfies a respective threshold criterion of a plurality of threshold criteria;
maintaining a load balancing pool for the containerized computing cluster based on a result of the determining, wherein the load balancing pool comprises a list of available RAN component entities; and
responsive to receiving a request of data traffic, distributing the data traffic to one or more RAN component entities selected from the load balancing pool.

9. The computing system of claim 8, wherein the plurality of RAN component entities comprise a plurality of DU entities,
wherein each health parameter characterizes a health status of at least one of: a stream control transmission protocol (SCTP) traffic, or a layer 1 (L1) or layer 2 (L2) service,
wherein the list of available RAN component entities comprises a list of available DU entities, and
wherein distributing the data traffic to the one or more RAN component entities selected from the load balancing pool comprises distributing the data traffic to one or more DU entities selected from the load balancing pool.

10. The computing system of claim 8, wherein the plurality of RAN component entities comprise a plurality of CU entities,
wherein each health parameter characterizes a health status of at least one of: a stream control transmission protocol (SCTP) traffic, or a layer 3 (L3) service,
wherein the list of available RAN component entities comprises a list of available CU entities, and
wherein distributing the data traffic to the one or more RAN component entities selected from the load balancing pool comprises distributing the data traffic to one or more CU entities selected from the load balancing pool.

11. The computing system of claim 8, wherein maintaining the load balancing pool for the containerized computing cluster based on the result of the determining comprises:
responsive to determining a plurality of health parameters associated with a first RAN component entity satisfy a first threshold criterion of the plurality of threshold criteria, adding the first RAN component entity to the load balancing pool.

12. The computing system of claim 8, wherein maintaining the load balancing pool for the containerized computing cluster based on the result of the determining comprises:
responsive to determining at least one health parameter of a plurality of health parameters associated with a second RAN component entity does not satisfy a second threshold criterion of the plurality of threshold criteria, removing the second RAN component entity from the load balancing pool.

13. The computing system of claim 8, wherein each threshold criterion of the plurality of threshold criteria comprises at least one of: a minimum value of a respective health parameter, a maximum value of the respective health parameter, or a range of values of the respective health parameter.

14. The computing system of claim 8, wherein the operations further comprise:
selecting the one or more RAN component entities from the load balancing pool according to a predefined load balancing policy, wherein the predefined load balancing policy comprises a round-robin algorithm.

15. One or more non-transitory, computer-readable storage media having computer-readable instructions thereon which, when executed by one or more processing devices, cause the one or more processing devices to perform operations comprising:
monitoring a plurality of health parameters associated with each radio access network (RAN) component entity of a plurality of RAN component entity in a containerized computing cluster of a cellular network, wherein each RAN component entity of the plurality of RAN component entities comprises a Distributed Unit (DU) entity or a Centralized Unit (CU) entity;
determining whether each health parameter of the plurality of health parameters satisfies a respective threshold criterion of a plurality of threshold criteria;
maintaining a load balancing pool for the containerized computing cluster based on a result of the determining, wherein the load balancing pool comprises a list of available RAN component entities; and
responsive to receiving a request of data traffic, distributing the data traffic to one or more RAN component entities selected from the load balancing pool.

16. The one or more non-transitory, computer-readable storage media of claim 15, wherein the plurality of RAN component entities comprise a plurality of DU entities,
wherein each health parameter characterizes a health status of at least one of: a stream control transmission protocol (SCTP) traffic, or a layer 1 (L1) or layer 2 (L2) service,
wherein the list of available RAN component entities comprises a list of available DU entities, and
wherein distributing the data traffic to the one or more RAN component entities selected from the load balancing pool comprises distributing the data traffic to one or more DU entities selected from the load balancing pool.

17. The one or more non-transitory, computer-readable storage media of claim 15, wherein the plurality of RAN component entities comprise a plurality of CU entities,
wherein each health parameter characterizes a health status of at least one of: a stream control transmission protocol (SCTP) traffic, or a layer 3 (L3) service,
wherein the list of available RAN component entities comprises a list of available CU entities, and
wherein distributing the data traffic to the one or more RAN component entities selected from the load balancing pool comprises distributing the data traffic to one or more CU entities selected from the load balancing pool.

18. The one or more non-transitory, computer-readable storage media of claim 15, wherein maintaining the load balancing pool for the containerized computing cluster based on the result of the determining comprises:
responsive to determining a plurality of health parameters associated with a first RAN component entity satisfy a first threshold criterion of the plurality of threshold criteria, adding the first RAN component entity to the load balancing pool.

19. The one or more non-transitory, computer-readable storage media of claim 15, wherein maintaining the load balancing pool for the containerized computing cluster based on the result of the determining comprises:
responsive to determining at least one health parameter of a plurality of health parameters associated with a second RAN component entity does not satisfy a second threshold criterion of the plurality of threshold criteria, removing the second RAN component entity from the load balancing pool.

20. The one or more non-transitory, computer-readable storage media of claim 17, wherein the operations further comprise:
selecting the one or more RAN component entities from the load balancing pool according to a predefined load balancing policy, wherein the predefined load balancing policy comprises a round-robin algorithm.
